(19) United States
(12) Patent Application Publication
(10) Pub. No.: US 2012/0025048 A1
(43) Pub. Date: Feb. 2, 2012

(54) Artist's palette and umbrella clamp

(76) Inventors: Ross William Pollard, Kenosha, WI (US); James Forest Pollard, Cazenovia, WI (US)

(21) Appl. No.: 12/804,700

(22) Filed: Jul. 27, 2010

(51) Int. Cl. F16B 2/02

(52) U.S. Cl. 248/316.1

(57) ABSTRACT

One embodiment of a device for mounting an artist's palette and shade umbrella to a tripod and of the type comprising a body having a clamping aperture on one edge thereof and a means of fastening an artist's palette and umbrella to said body. The body is made of a rigid and lightweight material to provide a stable and portable platform. Other embodiments are described and shown.

### CROSS-REFERENCE TO RELATED APPLICATION

Not Applicable

### FEDERALLY SPONCERED RESEARCH

Not Applicable

### SEQUENCE LISTING OR PROGRAM

Not Applicable

### BACKGROUND

1. Field

This application relates to artists' easels, specifically to a device for mounting an artist's palette and shade umbrella to a portable tripod.

2. Prior Art

For artists interested in pursuing their art in the great outdoors, finding an adequate portable surface to store and work with paint and other materials has historically been a difficult task. Collapsible wooden easels have been the mainstay of artists in search of an easel with a portable storage/work surface. See e.g. U.S. Pat. No. 7,188,818 B2. In their simplest form, such easels feature a palette that is permanently affixed via hinges to an easelback. On many units, a threaded hole for mounting said unit onto a photographic tripod is also provided. However, the palettes on such easels are small and cannot be raised or lowered independently of the easelback. In the studio, most artists prefer to mix paint on a large palette close to waist level while keeping their painting surface closer to eye level. This is impossible under the cramped conditions found on such easels. Additionally, the high center of gravity on such easels makes it difficult to secure an artist's umbrella to the device without compromising stability. Such umbrellas are used by outdoor painters to shade their painting from the sun and create neutral lighting conditions.

An attempt to solve some of these problems utilizes a removable artist's shelf, or palette that fits on the legs of a tripod. See U.S. Pat. No. 6,240,857 B1. However, because the shelf only fits in one position on the tripod and cannot be firmly locked in place, the practicality of such a device is limited.

### SUMMARY

In accordance with one embodiment, an artist's palette and umbrella clamp comprises a body of material having a clamping aperture on one edge thereof and a means of fastening an artist's shade umbrella and palette to said body.

### DRAWINGS—FIGURES

In the drawings, closely related figures have the same number but different alphabetic suffixes.

FIG. 1 shows a front perspective view of one embodiment of an artist's palette and umbrella clamp.

FIGS. 2A and 2B show fragmentary front perspective views of an artist's palette and umbrella clamp being attached to a typical portable tripod.

FIGS. 3A and 3B show fragmentary front perspective views of a notched palette being attached to an artist's palette and umbrella clamp.

FIG. 4 shows a front perspective view of an artist's clamp-on shade umbrella.

FIG. 5 shows a fragmentary front perspective view of a clamp-on umbrella attached to the artist's palette and umbrella clamp assembly of FIG. 3B.

FIG. 6 shows a front perspective view of an additional embodiment of an artist's palette and umbrella clamp with holes and slots.

FIG. 7 shows a front perspective view of an artist's shade umbrella with wingknob fastener.

FIG. 8 shows a fragmentary front perspective view of an artist's shade umbrella with wingknob fastener attached to the artist's palette and umbrella clamp of FIG. 6.

### REFERENCE NUMERALS

10 clamp body
12 clamping aperture
14 clamp screw
16 panel screws
18 tripod center column
20 notched palette
22 notches
24 umbrella clamp
25 umbrella arm
26 holes
27 slots
28 wingknob fastener

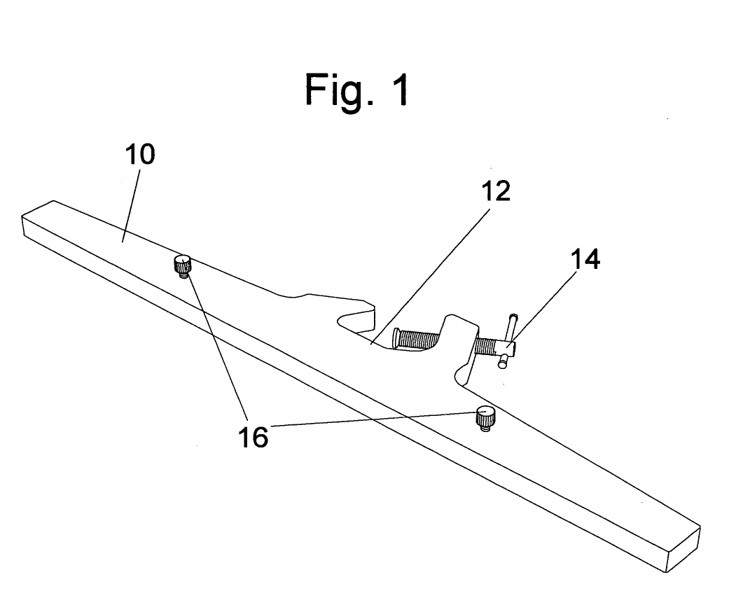

### DETAILED DESCRIPTION—FIG. 1

### First Embodiment

One embodiment of an artist's palette and umbrella clamp is illustrated in FIG. 1 (front perspective view). The artist's palette and umbrella clamp comprises a body (10) with clamping aperture (12), and panel screws (16) threaded into face of said body. In the preferred embodiment the clamp body is made of aluminum, although any suitably rigid and lightweight material may also be used.

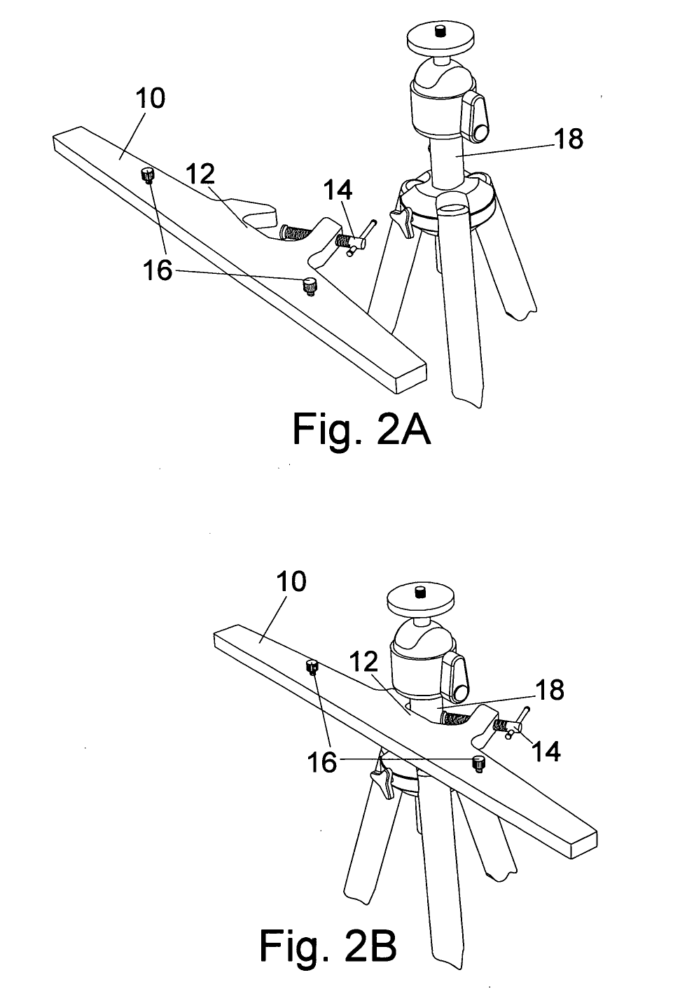

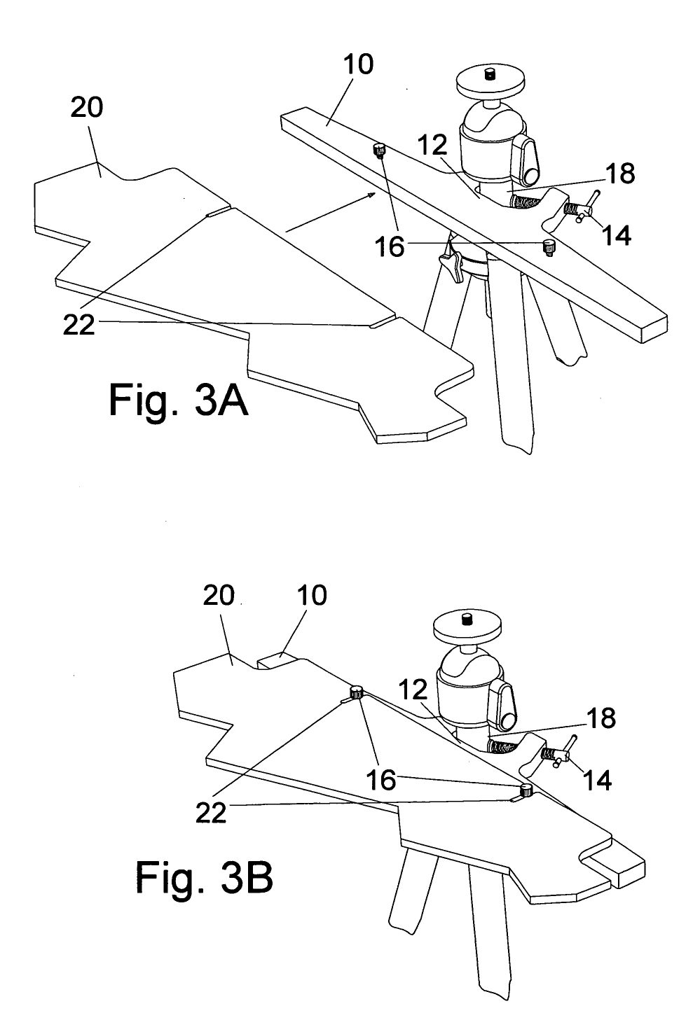

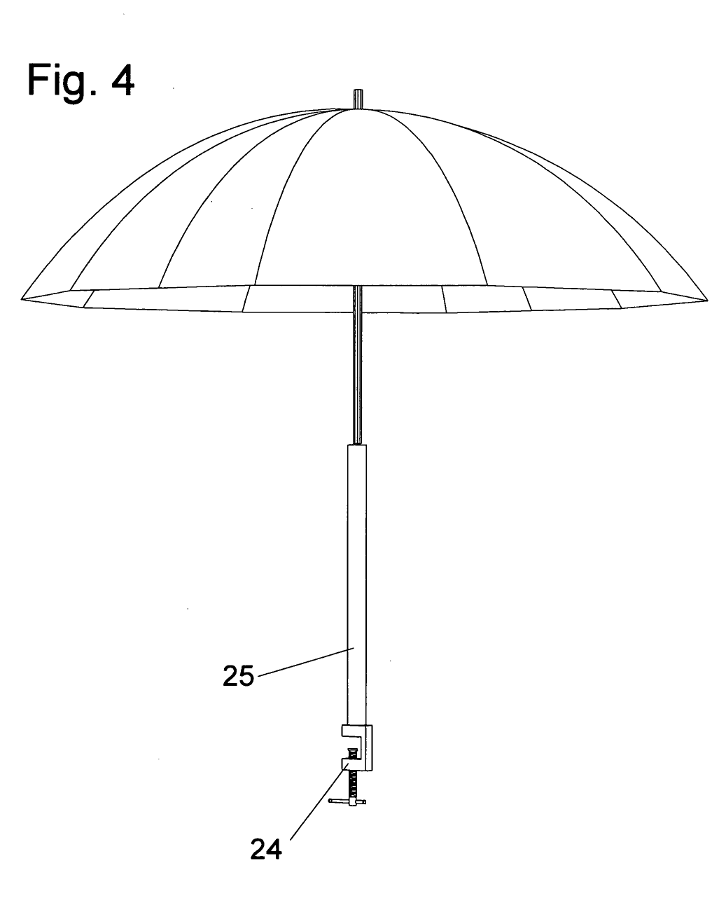

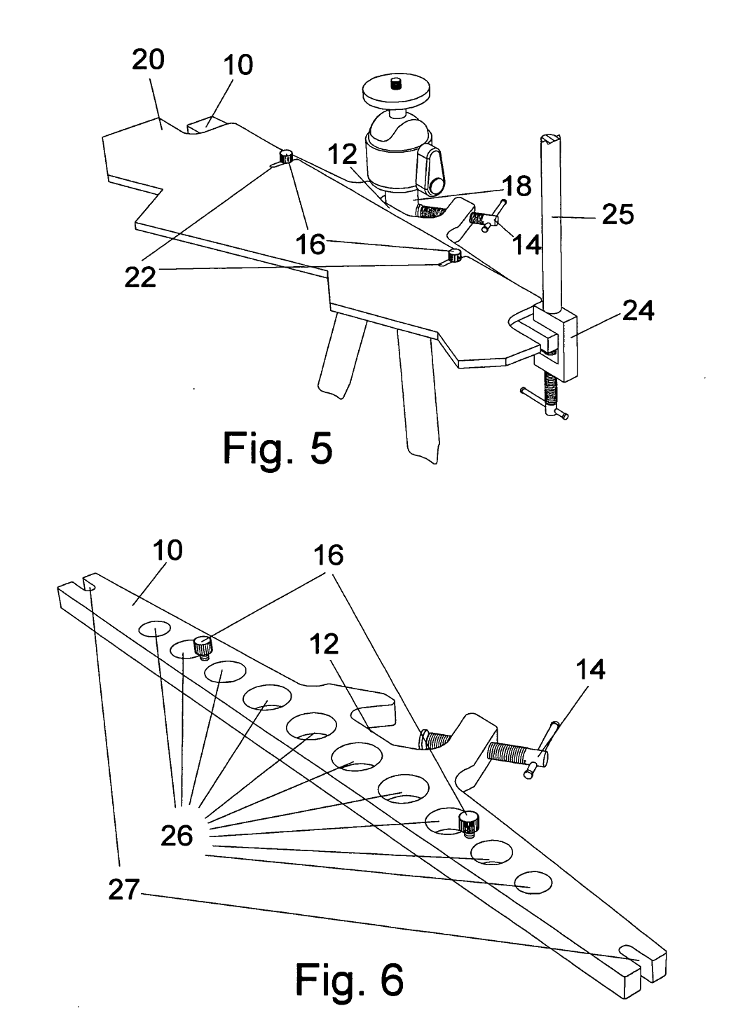

### Operation-FIGS. 2A-5

The palette clamp is secured to the center column of a standard photographic tripod using the clamp screw (14). Thumbscrews (16) slide into notches (22) on a specially-notched palette (20). Tightening thumbscrews (16) locks palette in position. An artist's umbrella may be mounted via a clamp (24) to the ends of the body (10).

### FIG. 6-8-Additional Embodiments

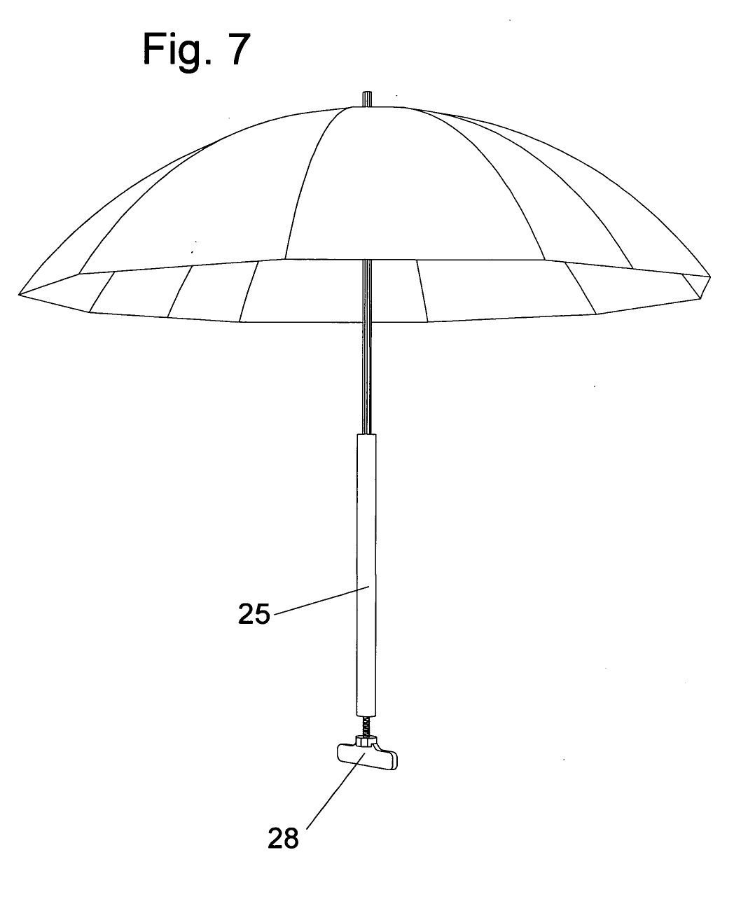

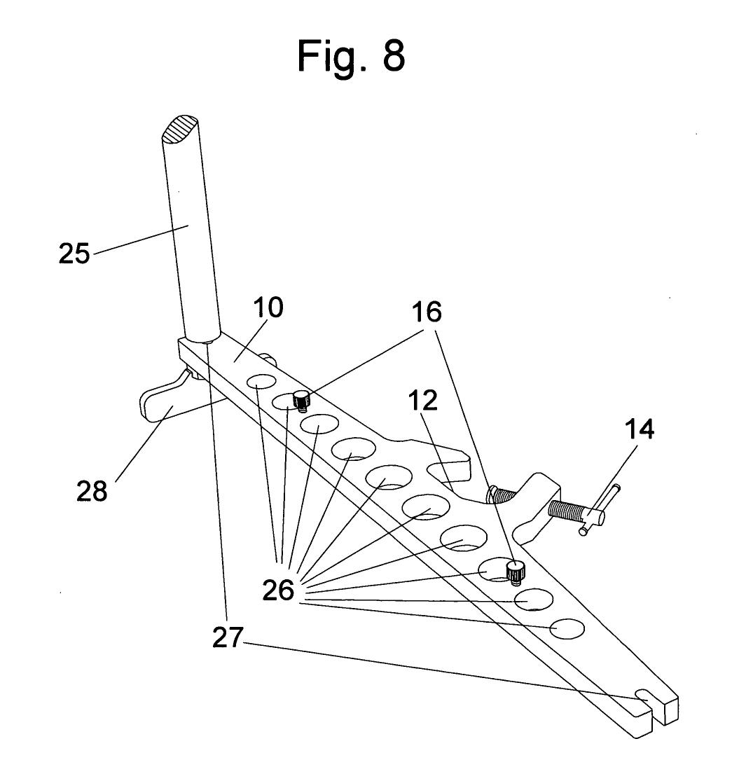

Additional embodiments are shown in FIG. 6. In FIG. 6 the artist's palette and umbrella clamp body has slots (27) for attaching an umbrella with a wingknob fastener (28) of the type illustrated in FIG. 7. Holes (26) lighten the clamp body. FIG. 8 shows an umbrella with a wingknob fastener attached to an artist's palette and umbrella clamp with slots and holes.

### Advantages

From the description above, a number of advantages of some embodiments of our artist's palette and umbrella clamp become evident:

(a) Thumbscrew fasteners accommodate interchangeable palettes of various shapes, sizes, and materials for use with different artists' mediums.

(d) One-piece body provides a sturdy platform for mounting an artist's shade umbrella.

(e) Clamping aperture allows palette to be locked securely into position at a comfortable height for the artist.

### Conclusion, Ramifications, Scope

Accordingly, the reader will see that at least one embodiment of the artist's palette and umbrella clamp provides a more portable and secure means of attaching an artist's umbrella and a wide variety of palette shapes and sizes onto a standard tripod. Furthermore, the artist's palette and umbrella clamp has the additional advantages in that:

it provides a rock-solid surface for mixing paint and storing materials;
it provides a means of attaching a wide variety of palette shapes and sizes onto a standard photographic tripod;
it provides a means of mounting an artist's shade umbrella to a tripod;
it provides a lightweight, portable solution for the traveling artist;
its compact size enables hassle-free storage.

While the above description contains many specificities, these should not be construed as limitations on the scope of any embodiment, but as exemplifications of the presently preferred embodiments thereof. Many other ramifications and variations are possible within the teachings of the various embodiments. For example, the clamp body may have other shapes; the panel screws may be replaced with other fasteners for use with un-notched palettes, etc.

Thus the scope of the embodiments should be determined by the appended claims and their legal equivalents, rather than by the examples given.

We claim:

1. In an artist's palette and umbrella clamp comprising a body of material having a clamping aperture on one edge thereof and a means of fastening an artist's shade umbrella and palette to said body.

2. The artist's palette and umbrella clamp of claim 1 wherein said body is machined from aluminum.

3. The artist's palette and umbrella clamp of claim 1 wherein said aluminum is anodized.

4. The artist's palette and umbrella clamp of claim 1 wherein said body has a plurality of threaded holes

5. The artist's palette and umbrella clamp of claim 1 wherein said threaded holes are fitted with threaded inserts.

6. The palette clamp of claim 1 wherein said body has one or more slots.

7. The artist's palette and umbrella clamp of claim 1 wherein said means of fastening a palette to said body is selected from the group consisting of thumbscrews and panelscrews.

8. The artist's palette and umbrella clamp of claim 1 wherein said clamping aperture has a fastener selected from the group consisting of screw clamps.
